(19) United States
(12) Patent Application Publication
(10) Pub. No.: US 2018/0192624 A1
(43) Pub. Date: Jul. 12, 2018

(54) LURE CAMERA

(71) Applicant: Quan Xing Electronic Technology (ShenZhen) Co., LTD., Shenzhen (CN)

(72) Inventor: Han-Che CHEN, Taipei City (TW)

(21) Appl. No.: 15/681,625

(22) Filed: Aug. 21, 2017

(30) Foreign Application Priority Data
Jan. 12, 2017 (CN) 201720037319.0

(51) Int. Cl. A01K 85/16; H04N 7/18; A01K 97/00

(52) U.S. Cl. CPC A01K 85/16; A01K 97/00; H04N 7/183

(57) ABSTRACT

A lure camera is provided, including a case, a micro camera, a circuit board unit, and a waterproof button. The micro camera is disposed in the case for taking images of things that are outside of the case. The circuit board unit is disposed in the case and includes a circuit board electrically connected to the micro camera and a button switch installed on the circuit board. The waterproof button is disposed on the case and corresponds to the button switch, and includes a button body, an elastic waterproof film, and a securing member. The micro camera is controllable to start and stop recording by operating the waterproof button. The waterproof button prevents water from entering the lure camera.

### CROSS-REFERENCE TO RELATED APPLICATIONS

The present application claims priority of China Patent Application No. 201720037319.0 filed on Jan. 12, 2017, which is incorporated by reference herein in its entirety.

### BACKGROUND OF THE INVENTION

### Field of the Invention

The present invention relates to a lure camera, and especially relates to a lure camera with small volume and good waterproof property.

### Description of the Related Art

A lure camera can be used as a fake fishing lure to take images of an underwater environment, and especially of the fish that are attracted to the fake fishing lure. Therefore, these cameras are beloved by sports fishermen and other fishing enthusiasts. In order to achieve such underwater photography, the lure cameras on the market must be waterproof and are usually housed inside a lure-shaped case (e.g. one shaped like a fish, earthworm, or mollusk). However, the cost of using such a waterproof camera is high, and so the price of lure cameras remains high. Furthermore, the dimensions of the lure camera are limited by that of the waterproof camera and cannot be reduced. As a result, its efficacy as a fake fishing lure is affected.

### BRIEF SUMMARY OF THE INVENTION

Based on the existing technical issues, the object of the present invention is to provide a lure camera which does not need to use a waterproof camera, so its dimensions may be minimized and the cost may be reduced. Moreover, by disposing various waterproof mechanisms on the case of the lure camera, waterproofing may effectively be provided (i.e. water is prevented from entering the lure camera), allowing the user to operate the camera more easily.

In accordance with some embodiments of the present invention, a lure camera is provided, comprising a case, a micro camera, a circuit board unit, and a waterproof button. The micro camera is disposed in the case for taking images of outside of the case. The circuit board unit is disposed in the case. The circuit board unit comprises a circuit board electrically connected to the micro camera and a button switch installed on the circuit board. the waterproof button is disposed on the case and corresponds to the button switch in the case. The waterproof button comprises a button body, an elastic waterproof film, and a securing member. The waterproof film covers a first opening on the case and has a combining portion at a location that corresponds to the first opening. The combining portion recesses toward an inner portion of the case. The button body connects to the combining portion and protrudes from the first opening. The securing member affixes the waterproof film at the first opening. The micro camera is controllable to start and stop recording via the operation of the waterproof button. Water is prevented from entering the lure camera.

In accordance with some embodiments of the present invention, the lure camera further comprises a transparent waterproof plug. The waterproof plug connects to and encloses a second opening on the case. The micro camera is installed in the waterproof plug and takes images of outside of the case through the waterproof plug.

In accordance with some embodiments of the present invention, at least an O-ring is disposed between the waterproof plug and the second opening to prevent water from entering the lure camera through the second opening.

In accordance with some embodiments of the present invention, the micro camera is electrically connected to the circuit board of the circuit board unit through a flexible print circuit, and the waterproof plug is movable with respect to the second opening, wherein the waterproof plug has a protruding tab, and an image-capturing angle of the micro camera may be adjusted by toggling the tab.

In accordance with some embodiments of the present invention, the circuit board further comprises a digital image processor and at least one storage component, the digital image processor is installed on the circuit board to convert an output image signal of the micro camera to a digital image signal, and the storage component comprises an embedded multi-media card and/or an external memory card installed on the circuit board to store the digital image signal.

In accordance with some embodiments of the present invention, the lure camera further comprises a waterproof cover pivotally connected to the case, and the waterproof cover can close a third opening on the case in an openable and closable manner. The external memory card enters the case and is electrically connected to the circuit board of the circuit board unit through the third opening, or leaves the case through the third opening.

In accordance with some embodiments of the present invention, the circuit board unit further comprises a rechargeable battery and a connector, and the rechargeable battery is electrically connected to the circuit board. The connector is installed on the circuit board. The connector forms a port at the third opening. The connector connects to an external device through the port. The connector charges the rechargeable battery through the external device, or the connector exports the digital image signal stored in the storage component to the external device.

In accordance with some embodiments of the present invention, the lure camera further comprises a fin-shaped component movably affixed to the outer side of the waterproof cover.

In accordance with some embodiments of the present invention, the lure camera further comprises a waterproof ring disposed on the side of the waterproof cover that faces the third opening, or the side of the third opening that faces the waterproof cover, to prevent water from entering the lure camera through the third opening.

In accordance with some embodiments of the present invention, the circuit board unit further comprises a blue light-emitting diode installed on the circuit board, and emits blue light to the outside through the case.

### BRIEF DESCRIPTION OF THE DRAWINGS

The present invention can be more fully understood by reading the subsequent detailed description and examples with references made to the accompanying drawings, wherein:

FIG. 1 illustrates the appearance of the lure camera, in accordance with some embodiments.

FIG. 2 illustrates the case and the inner components of the lure camera in FIG. 1 viewing from a perspective.

FIG. 3 illustrates the case and the inner components of the lure camera in FIG. 1 viewing from another perspective.

FIG. 4 illustrates the location relationship between the waterproof button on the case and the button switch in the case in FIG. 1.

FIG. 5 is an illustration of the case when the waterproof cover on the case is open.

FIG. 6 is a top view of the lure camera, in accordance with some embodiments.

FIG. 7 is a rear view of the lure camera, in accordance with some embodiments.

### DETAILED DESCRIPTION OF THE INVENTION

Hereinafter, the present disclosure will be described with reference to some embodiments. It should be understood that the embodiments are not intended to limit the scope of the present disclosure.

The present invention may repeat reference numerals and/or letters in the various examples. This repetition is for the purpose of simplicity and clarity and does not in itself dictate a relationship between the various embodiments and/or configurations discussed. It should be noted that in the following embodiments of the present disclosure, the shape and the thickness may be enlarged for simplicity or convenient labeling. Furthermore, the components which are not shown in the figures or the description are known by persons skilled in the art.

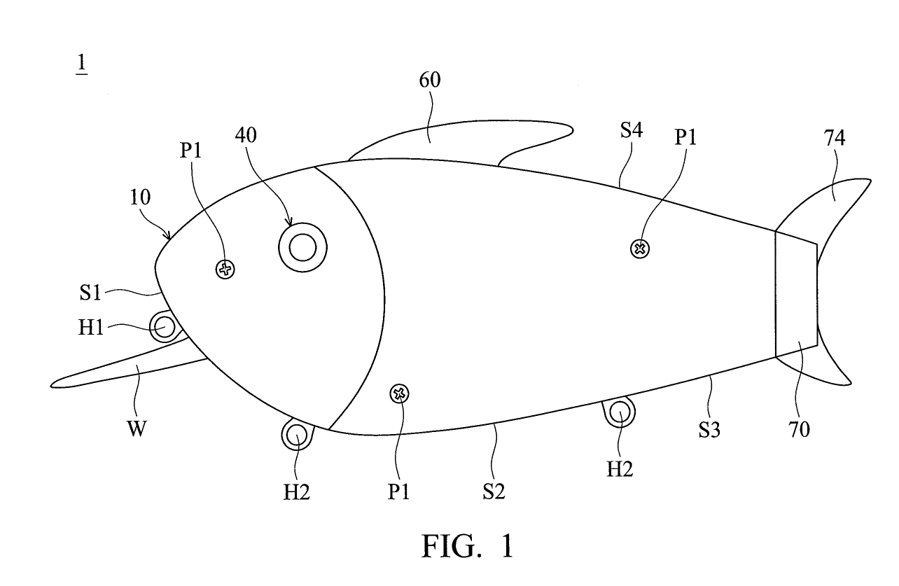

Referring to FIGS. 1-3, in some embodiments of the present invention, the lure camera 1 includes a fish-shaped case 10. It should be understood that the appearance of the case 10 may be changed to meet the user's requirements. For example, it may be designed to look like a mollusk (such as an octopus, etc.). It can be found from FIGS. 1-3 that the case 10 includes a first case portion 11 and a second case portion 12, wherein the shapes of the two case portions are symmetrical and an accommodation space R is formed in their inner side to accommodate other electronic components of the lure camera 1 (which will be described later). In some embodiments, the material of the first and second case portions 11 and 12 includes plastic or acrylic resin. The assembly may be accomplished by passing screws P1 through screw holes P2 on the first and second case portions 11 and 12.

In some embodiments, textures such as scale may be formed on the case 10 and/or the case 10 may be colored by, for example, painting to give the lure camera 1 the appearance of a real fish.

In some embodiments, a first connection feature H1 and a wave board W may be configured at the front side S1 of the case 10, wherein the first connection portion is, for example, a hole structure to connect a fishing line, and the wave board W is, for instance, a flat structure to allow the lure camera 1 to bob up and down (the way a real fish swims) in water when the user pulls on the fishing line. Furthermore, at least one second connection feature H2 may be configured at the bottom side S2 of the case 10, wherein the second connection portion may be, for example, a hole structure to attach a fish hook. It should be noted that the location and the amount of the first connection feature H1, the second connection feature H2 and the wave board W is not limited by the embodiment of FIGS. 1-3, and can be adjusted (or omitted) depending on the user's requirements.

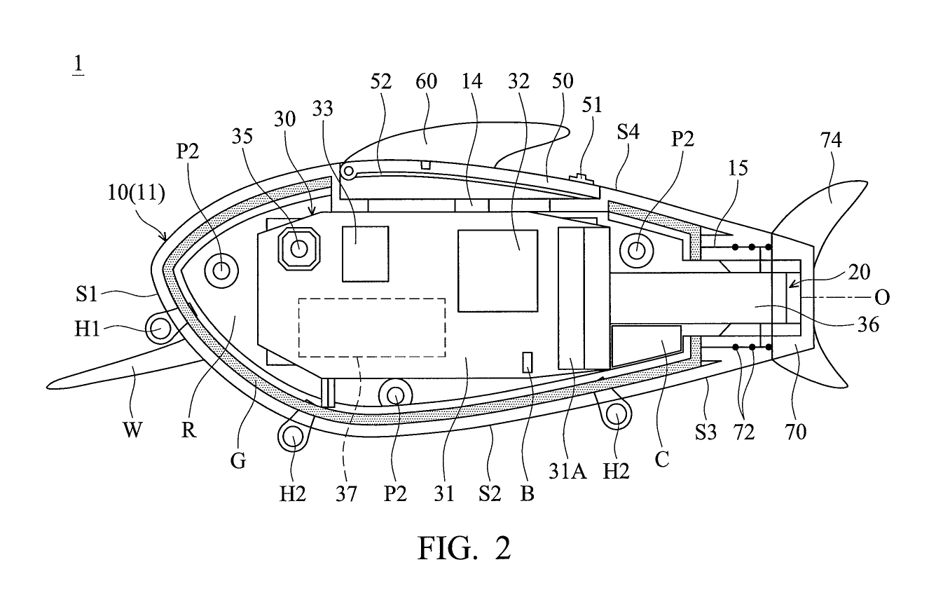

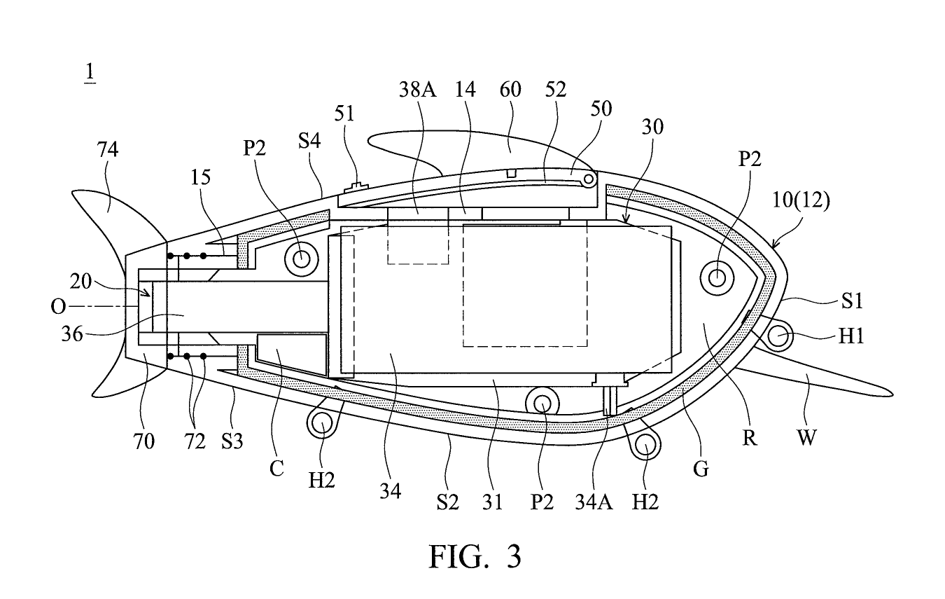

As shown in FIGS. 2 and 3, a micro camera 20 and a circuit board unit 30 are disposed in the accommodation space R of the case 10. In some embodiments, the location of the micro camera 20 is close to the rear side S3 of the case 10 and has an image-capturing optical axis O extending toward an outer side of the case 10 such that the micro camera 20 may take images of outside of the case 10. It should be understood that a fish shoal may generally chase the rear of the fake lure, so the micro camera is configured at the rear of the lure camera to more easily catch an image of the fish shoal. However, in the present invention, the location of the micro camera is not limited and can be adjusted depending on actual requirements. The circuit board unit 30 is substantially disposed at the center of the accommodation space R and may be electrically connected to the micro camera 20 to provide electricity for the micro camera 20 to record video and to process the output signal of the micro camera 20.

More specifically, in some embodiments, the circuit board unit 30 includes a circuit board 31, a digital image processor (DIP) 32, a storage component 33, a rechargeable battery 34, and a button switch 35. The micro camera 20 may be electrically connected to a camera connection terminal 31A through a flexible printed circuit (FPC) 36. The digital image processor 32 is installed on the circuit board 31 to convert the output image signal of the micro camera 20 to a digital image signal. The storage component 33 is, for example, an embedded multi-media card (EMMC) installed on the circuit board 31 to store the digital image signal. The rechargeable battery 34 may be electrically connected to the circuit board 31 through a battery terminal 34A for providing electricity to the circuit board 31 and the electronic components thereon. The button switch 35 is installed on the circuit board 31. By operating (pressing) the button switch 35, a determination may be made as to whether or not the circuit board 31 and the micro camera 20 are electrically connected, and thus the micro camera 20 is controlled to start and stop recording. For example, the micro camera 20 may start recording video when the button switch 35 is pushed, and pushing the button switch 35 again may stop the micro camera 20 from recording video. It should be understood that the circuit board 31 also includes a controlling circuit 37 thereon to control the operation of the whole circuit board unit 30 and the micro camera 20 connected thereto.

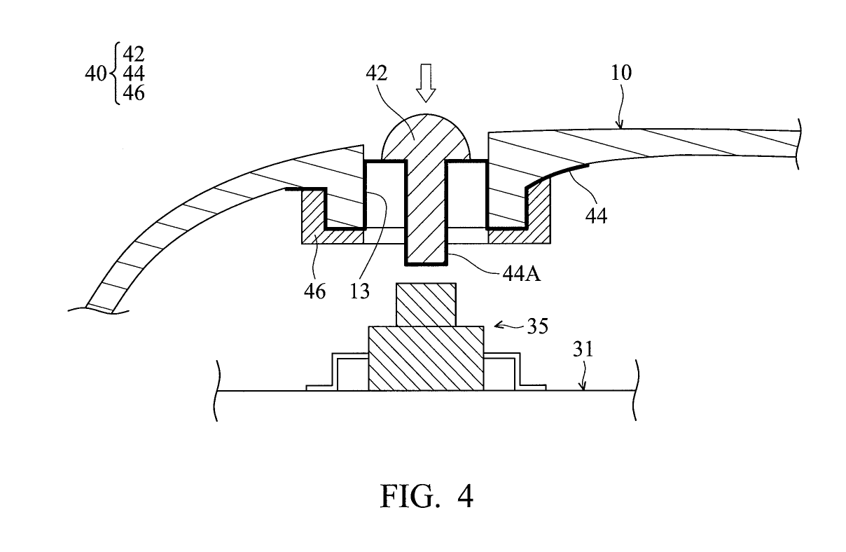

Referring to FIGS. 1 and 4, a waterproof button 40 is disposed on the case 10 and corresponds to the button switch 35 on the circuit board 31 in the case 10. The waterproof button 40 includes a button body 42, a waterproof film 44 and a securing member 46. The waterproof film 44 covers an opening 13 (the first opening) on the case 10. More specifically, the waterproof film 44 is, for instance, an elastic silicone film which may conform to the shape of the inner side of the opening 13 to tightly seal the opening 13. Furthermore, the waterproof film 44 includes a combining portion 44A recessing toward the inner portion of the case 10 at the location that corresponds to the opening 13. The button body 42 is, for instance, a rivet-shaped plastic member to attach to the combining portion 44A (e.g. by close-fitting or adhesion) and protrudes from the opening 13. The secure member is, for example, a plastic retaining ring, and may be engaged at the inner side of the case 10 and may affix the waterproof film 44 to the opening 13. Furthermore, the combining portion 44A of the button body 42 and the waterproof film 44 may extend through the securing member 46.

As a result, when the user operates (presses) the waterproof button 40 (as shown in the arrow of FIG. 4), the button switch 35 on the circuit board 31 in the case 10 may also be operated (pressed). Therefore, the micro camera 20 may be controlled to start and stop recording videos. For example, the micro camera 20 may start recording video when the waterproof button 40 is pushed, and the micro camera 20 may stop recording video when the waterproof button 40 is pushed again. At the same time, the waterproof button 40 may prevent water from entering the lure camera. It should be noted that in some embodiments, the waterproof button 40 is configured at the fisheye location of the lure camera 1 (as shown in FIG. 1). Therefore, in addition to practicality, it also has the effect of aesthetics. However, the waterproof button 40 may correspond to the location of the button switch 35 and thus may be disposed elsewhere on the case 10.

As described above, the lure camera 1 in the previous embodiments (FIGS. 1-4) does not need a waterproof camera to achieve the function of underwater photography. Furthermore, because in lure camera 1 the waterproof camera was replaced by a smaller and cheaper micro camera 20 and circuit board unit 30, its volume and cost may be reduced (the selling price may also be reduced to attract more customers).

More specifically, referring to FIGS. 2 and 3, the inner side of the case 10 may be covered by a waterproof ring G to enhance the waterproof properties of the lure camera 1, wherein the material of the waterproof ring G is, for example, silicone. Furthermore, a weight-balanced block C may be disposed in a suitable location of the lure camera 1 to balance the weight of the lure camera 1, wherein the material of the weight-balanced block C may be, for instance, metal.

Further, in order to enhance the operational convenience of the lure camera and/or to add additional functions to the lure camera 1, the following designs are also included in the embodiment of the present invention.

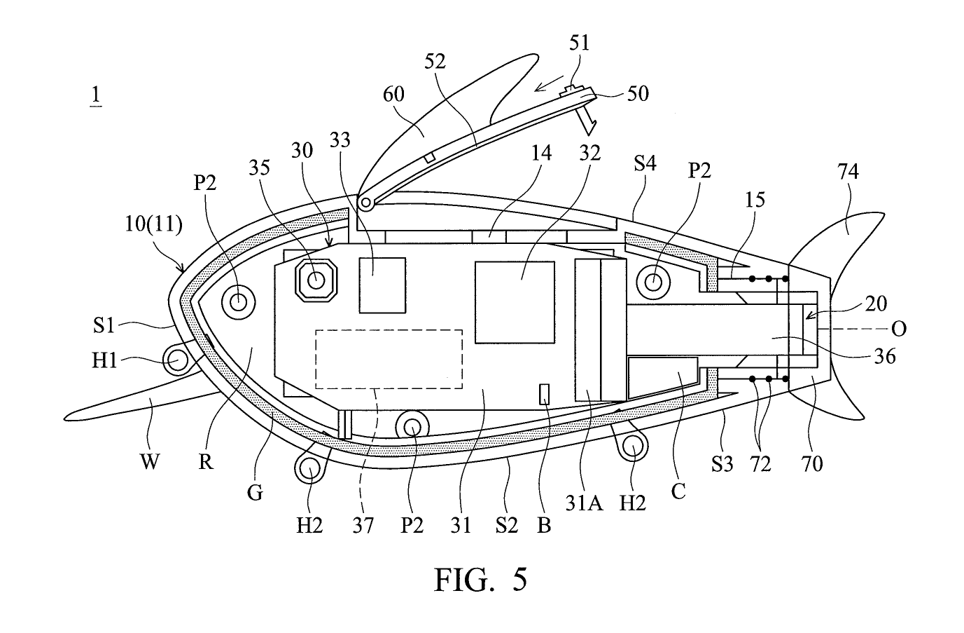

Referring to FIGS. 2, 3 and 5, in some embodiments, the circuit board unit 30 further includes a connector 38 (FIG. 3) installed on the circuit board 31, such as a universal serial bus (USB) connector. Furthermore, an opening 14 (the third opening) and a waterproof cover 50 are disposed on a location of the case 10 that corresponds to the connector 38, such as the upper side S4 of the case 10, wherein the waterproof cover 50 pivotally connects to the case 10, and may close the opening 14 in an openable and closable manner. For example, a latch member 51 is disposed on the waterproof cover 50. When the waterproof cover 50 is closed, the latch member 51 and an engagement structure (not shown) on the case 10 may be combined. Therefore, the waterproof cover 50 may tightly seal the opening 14. When the user wants to open the waterproof cover 50, only the latch member 51 on the waterproof cover 50 should be pushed (as shown by the arrow in FIG. 5) to separate the waterproof cover 50 and the engagement structure. Therefore, the waterproof cover 50 may be successfully opened (FIG. 5). A port 38A of the connector 38 may be formed at the opening 14.

When the waterproof cover 50 is opened, the port 38A of the connector 38 may allow the lure camera to connect with an external device (such as computer, not shown) by the above design. As a result, the external device may be utilized to charge the rechargeable battery 34 of the lure camera 1, or the digital image signal stored in the storage component 33 may be exported to the external device. When the waterproof cover 50 is closed, it may seal the opening 14 and prevent water from entering the lure camera 1. As shown in FIGS. 2 and 3, to enhance the waterproof properties of the waterproof cover 50, a waterproof ring 52 may be disposed on one side of the waterproof cover 50 facing the opening 14, or it may be disposed on one side of the opening 14 facing the waterproof cover 50 (not shown). The material of the waterproof ring 52 may, for example, be silicone. Therefore, water may be prevented from entering the lure camera through the opening 14. The material of the waterproof cover 50 may be the same as that of the case 10.

As shown in FIG. 3, in some embodiments, the circuit board unit 30 may further include an external media card 39 (storage component), such a microSD card, to store the digital image signal from the digital image processor 32, and it may increase the storage of the lure camera. When the waterproof cover 50 is opened, the external memory card 39 may enter the case 10 and be electrically connected to the circuit board 31 of the circuit board unit 30 through the opening 14 (the third opening), or it may leave the case 10 (lure camera) through the opening 14, and thus the data therein may be read by a card-reader. It should be noted that, in some embodiments, in order to reduce the manufacturing cost, the storage component 33 of the circuit board unit 30 may only use either the embedded multi-media card or the external memory card.

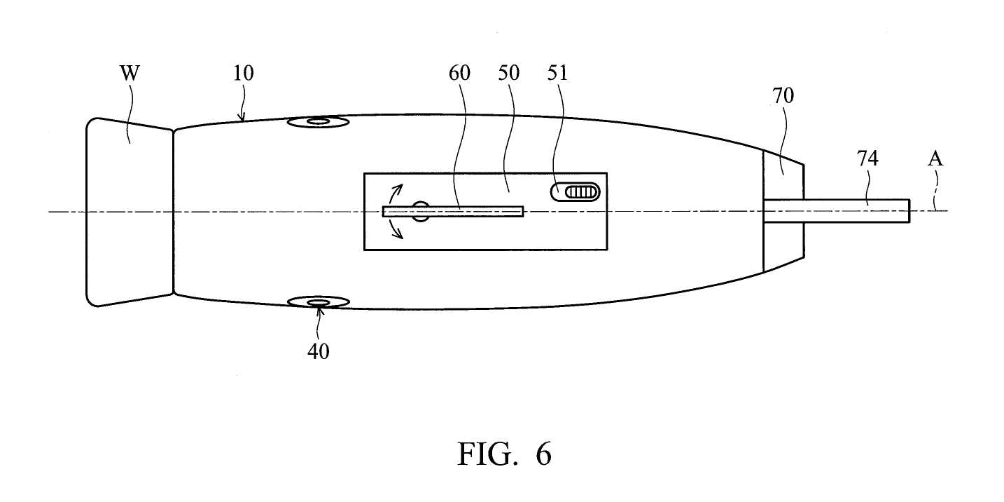

As shown in FIGS. 2 and 6, in some embodiments, a fin-shaped component 60 is installed on the outer side of the waterproof cover 50. The fin-shaped component 60 may be movably installed on the waterproof cover 50. As a result, the swimming mode and the direction of the lure camera in the water may further be changed by turning the fin-shaped component 60 (as shown in the arrow in FIG. 6) to adjust its angle with respect to the center line A of the lure camera. The material of the fin-shaped component 60 may be silicone.

Referring to FIGS. 2, 3 and 7, in some embodiments, an opening 15 (the second opening) and a waterproof plug 70 may be included at a location on the case 10 that corresponds to the micro camera 20 (e.g. the rear side S3 of the case 10), wherein the waterproof plug 70 is connected to and seals the opening 15. More specifically, one side of the waterproof plug 70 may be inserted and engaged in the opening 15, and thus it achieves the effect of sealing the opening 15. To enhance the waterproof properties of the waterproof plug 70, at least one O-ring 72 may be disposed between the waterproof plug 70 and the opening 15. Therefore, water may effectively be prevented from entering the lure camera through the opening 15.

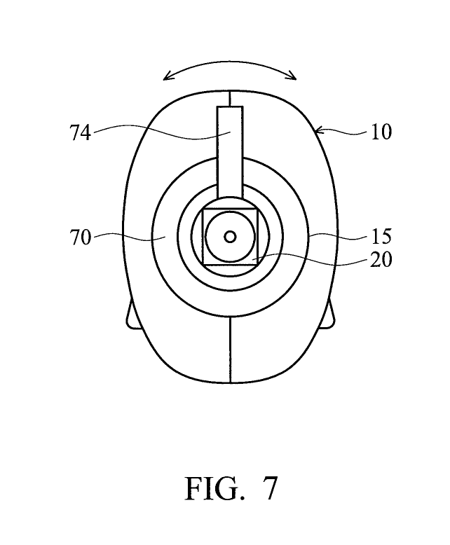

Furthermore, the micro camera 20 may be installed (secured) in the waterproof plug 70, and it may take images of outside of the case 10 through the (transparent) waterproof plug 70. The waterproof plug 70 may include acrylic resin material. The waterproof plug 70 may move (i.e. rotate) with respect to the opening 15, and the waterproof plug 70 has a protruding tab 74. It should be noted that the micro camera 20 installed in the waterproof plug 70 is connected to the circuit board 31 through the flexible print circuit 36, so the micro camera 20 and the flexible print circuit 36 may rotate along with the waterproof plug 70 when the tab 74 of the waterproof plug 70 is toggled. In other words, the micro camera 20 may be rotated by toggling the tab 74 (as shown by the arrow in FIG. 7), and thus its image-capturing angle may be changed. As a result, in addition to enhancing the performance of the lure camera (which has many variations of image-capturing angles), the joy of operation may be also increased.

Referring to FIG. 2, a blue light-emitting diode B is included on the circuit board 31 of the circuit board unit 30, which may emit blue light to the outside through the case 10 to attract a shoal of fish to come closer to the lure camera in some embodiments.

In summary, a lure camera is provided in the present invention, wherein size minimization and cost reduction may be achieved without using a waterproof camera. Furthermore, by disposing various waterproof mechanisms on the case of the lure camera, a waterproofing effect may be provided (i.e. preventing water from entering the lure camera), which may help the user to operate the camera.

The description above is only embodiments of the present the disclosure, and should not be used to limit the present disclosure. For a person skilled in the art, various changes and variations may be included in the present disclosure. The features of the embodiments may be used together and depend on the requirements, and is not limited. Any variation, equivalent replacement and improvement in the spirit and principle of the present disclosure should be protected in the present disclosure.

What is claimed is:

1. A lure camera, comprising:
a case;
a micro camera disposed in the case for taking images of outside of the case;
a circuit board unit disposed in the case, wherein the circuit board unit comprises a circuit board electrically connected to the micro camera and a button switch installed on the circuit board; and
a waterproof button disposed on the case and corresponding to the button switch in the case, wherein the waterproof button comprises a button body, an elastic waterproof film and a securing member, wherein the waterproof film covers a first opening on the case and has a combining portion at a location corresponding to the first opening, and the combining portion recesses toward an inner portion of the case, wherein the button body connects to the combining portion and protrudes from the first opening, the securing member affixes the waterproof film at the first opening, the micro camera is controllable to start and stop recording by operating the waterproof button, and water is prevented from entering the lure camera.

2. The lure camera as claimed in claim 1, further comprising a transparent waterproof plug, wherein the waterproof plug connects to and encloses a second opening on the case, and the micro camera is installed in the waterproof plug and takes images of outside of the case through the waterproof plug.

3. The lure camera as claimed in claim 2, wherein at least an O-ring is disposed between the waterproof plug and the second opening to prevent water from entering the lure camera through the second opening.

4. The lure camera as claimed in claim 3, wherein the micro camera is electrically connected to the circuit board of the circuit board unit through a flexible print circuit, and the waterproof plug is movable with respect to the second opening, wherein the waterproof plug has a protruding tab, and an image-capturing angle of the micro camera may be adjusted by toggling the tab.

5. The lure camera as claimed in claim 1, wherein the circuit board further comprises a digital image processor and at least one storage component, the digital image processor is installed on the circuit board to convert an output image signal of the micro camera to a digital image signal, and the at least one storage component comprises an embedded multi-media card and/or an external memory card installed on the circuit board to store the digital image signal.

6. The lure camera as claimed in claim 5, further comprising a waterproof cover pivotally connected to the case, and the waterproof cover can close a third opening on the case in an openable and closable manner, wherein the external memory card enters the case and is electrically connected to the circuit board of the circuit board unit through the third opening, or leaves the case through the third opening.

7. The lure camera as claimed in claim 6, wherein the circuit board unit further comprises a rechargeable battery and a connector, and the rechargeable battery is electrically connected to the circuit board, wherein the connector is installed on the circuit board, forms a port at the third opening, connects to an external device through the port, and charges the rechargeable battery through the external device, or exports the digital image signal stored in the storage component to the external device.

8. The lure camera as claimed in claim 6, further comprising a fin-shaped component movably affixed to an outer side of the waterproof cover.

9. The lure camera as claimed in claim 6, further comprising a waterproof ring disposed on a side of the waterproof cover facing the third opening or a side of the third opening facing the waterproof cover to prevent water from entering the lure camera through the third opening.

10. The lure camera as claimed in claim 1, wherein the circuit board unit further comprises a blue light-emitting diode installed on the circuit board, and emits blue light to the outside through the case.
